(19) United States
(12) Patent Application Publication
(10) Pub. No.: US 2018/0147996 A1
(43) Pub. Date: May 31, 2018

(54) BIKE CARRIER

(71) Applicant: Erol Caglarcan, Greenville, SC (US)

(72) Inventor: Erol Caglarcan, Greenville, SC (US)

(21) Appl. No.: 15/826,784

(22) Filed: Nov. 30, 2017

Related U.S. Application Data
(60) Provisional application No. 62/428,042, filed on Nov. 30, 2016.

(51) Int. Cl. B60R 9/10; B60R 9/06

(52) U.S. Cl. CPC B60R 9/10; B60R 9/06

(57) ABSTRACT

A bike rack is provided that has a mounting assembly, such as a trailer hitch, for example, to attach the bike rack to a vehicle; a frame having a first section joined to the mounting assembly, the first section having a first end at substantially one side of the vehicle that continues to extend past the mounting assembly, and a second section that is joined to the first section at a second end opposite to the first end of the first section, the second section extending substantially to a side opposite of the one side of the vehicle; and a floor mounted to the first section. The bike rack ma be configured such that the first section is substantially horizontal relative to the vehicle when attached to the vehicle, while the second section is substantially vertical relative to the vehicle when a bicycle is mounted to the bike rack. Additionally, a pad may be positioned over a top of the second section to assist in further securing a bicycle to the bike rack without causing the bike rack to suffer from damage. The second section may rotatably pivoted downward and over a portion of the first section. Additionally, the second section may be telescoping to expand or reduce to adjust to the size of the bicycle. A pivoting third section may additionally be attached to the first end of the first section at a side opposite of where the second section is attached.

### CROSS-REFERENCE TO RELATED APPLICATIONS

This application claims priority to co-pending U.S. Provisional Application No. 62/428,042, filed on Nov. 30, 2016, which is incorporated herein by reference in its entirety.

### FIELD OF INVENTION

The present invention relates to a bike carrier or bike rack that are mounted to vehicles. The invention also provides a method for using such bike carriers or bike racks.

### BACKGROUND

Conventional bicycle carriers are usually installed on a lower portion of the rear end of vehicle. An ordinary car having a trunk, the trunk cover is pivoted upward and frontward when opening the trunk cover. Thus, the bicycle carrier may not hinder the pivoting of the trunk cover.

Vehicles that do not have a trunk, such as a SUV or van, do not have a trunk cover, but, rather, a door for access to the rear of the vehicle. In order to open this door in the rear, the door is pivoted backward and possibly upward. Thus, the rear door may not be smoothly opened due to a hindrance caused by the bicycle carrier. As a result, in order to open the rear door, the bicycle carrier typically must be detached prior to accessing the rear of the vehicle

Conventional bicycle carriers also fail to safely carry bicycles of varying sizes, whether large of small. This is often experienced by families traveling with their bicycles.

The present invention provides a bike carrier or bike rack for mounting to a vehicle that overcomes the problems caused by conventional bicycle racks.

### SUMMARY

In some embodiments of the invention, the presently disclosed subject matter is directed to a bike carrier or bike rack that may be mounted to a vehicle. Particularly, the bike carrier or bike rack has a mounting assembly to attach the bike rack to a vehicle, a frame having a first section and a second section, and a floor mounted to the first section.

An aspect of the invention provides a bike carrier or bike rack comprising a mounting assembly to attach the bike rack to a vehicle; a frame having a first section joined to the mounting assembly, the first section having a first end at substantially one side of the vehicle that continues to extend past the mounting assembly, and a second section joined to the first section at a second end opposite to the first end of the first section, the second section extends substantially to the other side opposite of the one side of the vehicle; and a floor mounted to the first section. In a preferred embodiment of the invention, upon attachment of the bike rack to the vehicle, the first section is substantially horizontal relative to the vehicle, while the second section is substantially vertical relative to the vehicle when a bicycle is to be mounted to the bike rack. In certain embodiments of the invention, the mounting assembling is a trailer hitch.

In an embodiment of the invention, the floor of the frame comprises perforations. In certain embodiments of the invention, the perforations may be geometrically shaped, such as in the shape of a diamond, for example. In certain embodiments of the invention, the floor is a flat planar surface.

In certain particular embodiments of the invention, the first section occupies in the range of from 50 to 70 percent of an overall length of the bike rack. In yet other embodiments of the invention, a width of the bike rack is from 0.45 meter to 1.1 meters.

In an embodiment of the invention, the bike rack additionally has a pad that is positioned over a top of the second section. Further pursuant to this embodiment of the invention, the second section is configured to be positioned between a down tube and a front fork of the bicycle and the down tube rests on the pad. In a more specific embodiment of the invention, and more typical to its use, the top of the second section is positioned below the fork crown.

In certain embodiments of the invention, a front wheel of the bicycle extends beyond the second section and below the frame and the front wheel is not directly supported by the bike rack. In still other embodiments of the invention, a rear wheel of the bicycle rests on the floor of the first section.

In an embodiment of the invention, the second section may rotatably pivot downwardly and over a portion of the first section. In certain embodiments of the invention, the bike rack may additionally have a pivoting third section attached to the first end of the first section.

In certain embodiments of the invention, a length of the second section may be configured to telescope to expand or reduce to adjust to the size of the bicycle. Further pursuant to this embodiment of the invention, a section of the second section may slidably engage an additional section and a pin is inserted into corresponding selected voids of each of the sections of the second section to selectively choose a preferred length for the second section.

Another aspect of the invention provides a method of using a bike rack comprising the steps of attaching a bike rack to a vehicle using a mounting assembly, the bike rack additionally comprising a frame having a first section joined to the mounting assembly and a second section joined to an end of the first section; pivoting the second section from a generally horizontal orientation relative to the vehicle to a generally vertical orientation relative to the vehicle; positioning a bicycle so that a length of a frame of the bicycle is generally perpendicular to a direction of travel of the vehicle and the second section is positioned between a front fork and a down tube of the bicycle with the down tube of the bicycle being supported by the upper most part of the second section; and placing a rear wheel of the bicycle on a floor of the first section.

In certain embodiments of the invention, the method for using a bike rack, may additionally have the step of securing a pad over an upper most part of the second section when in the generally vertical orientation with the down tube of the bicycle additionally being supported by the pad. In still other embodiments of the invention, the method of using the bike rack, additionally comprises securing the bicycle for travel to the bike rack with the use of at least one of a cable, a cord, and a line.

In certain embodiments of the invention, the method of using the bike rack may additionally include pivoting a third section attached to another end of the first section opposite to the end where the second section is attached.

Other aspects and embodiments will become apparent upon review of the following description taken in conjunction with the accompanying drawings. The invention, though, is pointed out with particularity by the included claims.

### BRIEF DESCRIPTION OF DRAWINGS

Having thus described the invention in general terms, reference will now be made to the accompanying drawings, which are not necessarily drawn to scale, and wherein:

FIG. 1 is a top plan view of a frame for a hitch mounted bike rack according to an embodiment of the invention;

FIG. 2 is a perspective view of the frame for a hitch mounted bike rack according to an embodiment of the invention;

FIG. 3 demonstrates the bike rack according to an embodiment of the invention mounted to a rear hitch of a vehicle;

FIG. 4 is another view of the bike rack according to an embodiment of the invention mounted to a rear hitch of a vehicle;

FIG. 5 demonstrates the bike rack according to an embodiment of the invention mounted to a rear hitch of a vehicle with multiple bicycles in position on the bike rack;

FIG. 6 is another view of the bike rack according to an embodiment of the invention mounted to a rear hitch of a vehicle with multiple bicycles in position on the bike rack;

FIG. 7 is a view of the bike rack according to an embodiment of the invention and in another configuration;

FIG. 8 is an enlarged partial view of the bike rack according to an embodiment of the invention featuring an axle about which one portion of the bike rack pivots relative to another portion of the bike rack;

FIG. 9 is a view of the bike rack according to an embodiment of the invention and in another configuration;

FIG. 10 is an example of a bicycle frame;

FIG. 11 is an elevation of a frame for a hitch mounted bike rack according to another embodiment of the invention, demonstrating a second section pivoting from a generally vertical position to a generally horizontal position;

FIG. 12 is the frame for a hitch mounted bike rack according to FIG. 11 with the second section folded to a generally horizontal position;

FIG. 13 is a perspective view of the frame for a hitch mounted bike rack according to another embodiment of the invention;

FIG. 14 is yet another embodiment of the invention demonstrating a second section and a third section pivoting from a generally vertical position to a generally horizontal position;

FIG. 15 shows second section 6, 106 as a telescoping member; and

FIG. 16 shows the telescoping second section of FIG. 15 in isolation.

### DESCRIPTION OF PREFERRED EMBODIMENTS

The present invention now will be described more fully hereinafter. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “a pad” includes a plurality of such pads.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

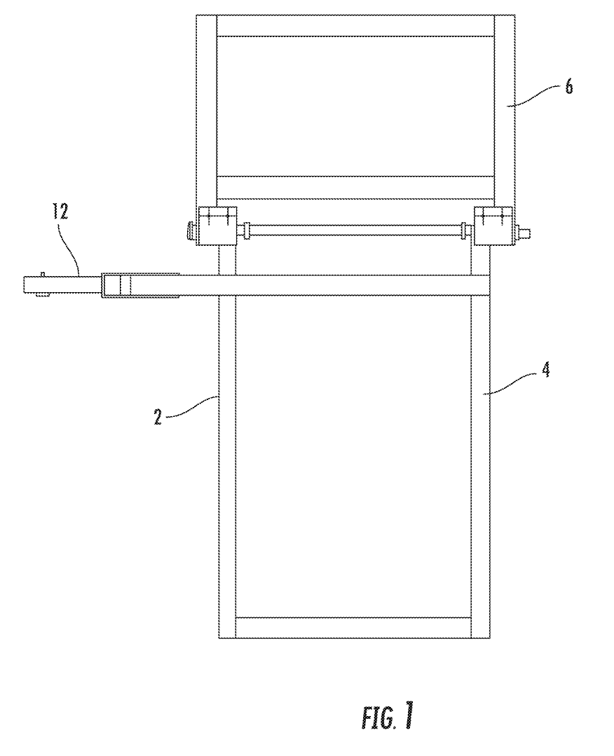

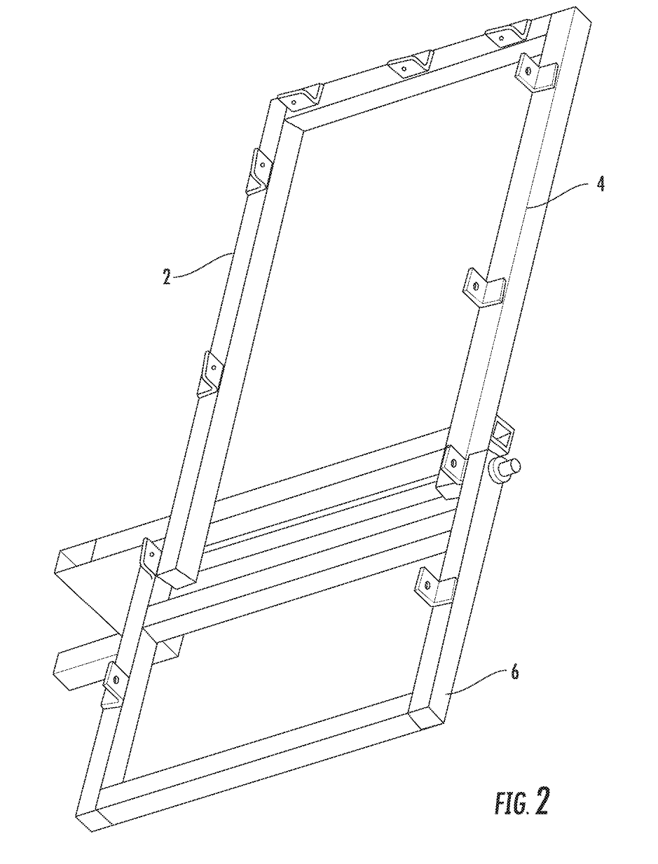

FIG. 1 is a top plan view of an exemplary frame 2 for a bike carrier or bike rack (“bike rack”) according to an embodiment of the invention. As shown, the bike rack has a first section 4 that is joined to a second section 6. The first end of the first section extends from approximately one side of the vehicle and past a trailer hitch 12. The second section of the frame is joined to the opposite end of the first section of the frame and extends to approximately the opposite side of the vehicle. The trailer hitch is joined to the first section of the frame. FIG. 2 shows the bottom of the frame in perspective view. The first section of the frame could be joined to the vehicle other than by a trailer hitch.

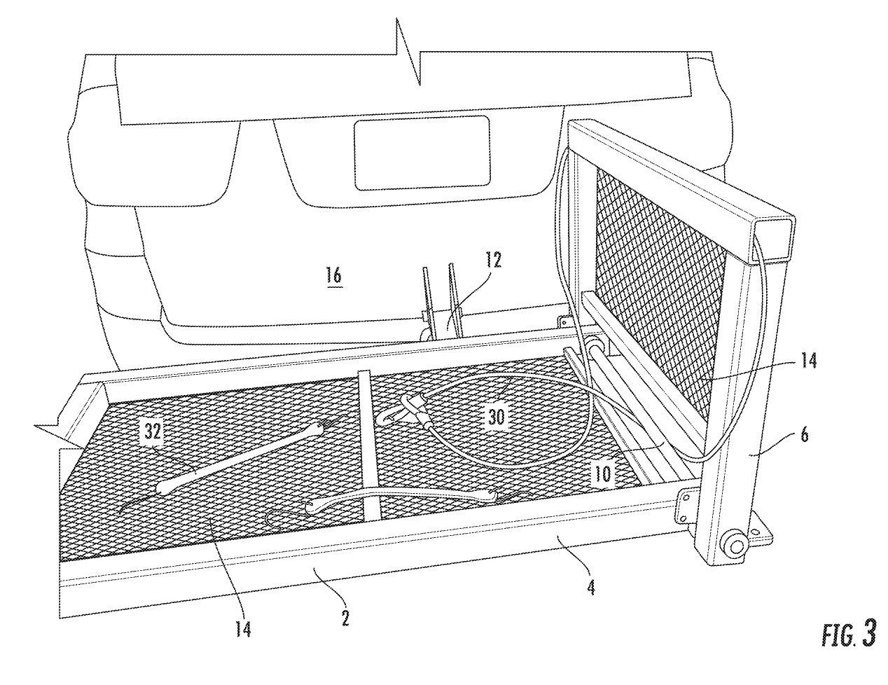

The first section 4 of the frame 2 is generally horizontal when mounted to a vehicle trailer hitch as shown in FIG. 3. The second section 6 of the frame is generally vertical in orientation, and is mounted to an end of the first section. The first section and the second section have a floor mounted to each of them, preferably on the bottom of the frame. The floor 14 is preferred to be perforated to allow drainage of water, and may be formed in geometric shapes, such as diamond shapes as shown. The floor is preferred to be a flat planar surface.

The first section 4 of the frame is preferred to extend to approximately one side of the vehicle 16, such as the left side of the vehicle as shown in the drawing figures. An opposite end of the first section of the frame extends past the trailer hitch mounting. In a preferred embodiment, 50 to 70 percent of the overall length of the frame is comprised in the first section 4.

In a preferred embodiment, the width of the frame is sufficiently wide enough for at least two bicycles to be positioned between opposing rails of the frame with the rear wheels of the bicycles resting on the floor of the first section of the frame and between the opposing rails. The width of the frame is preferably 0.45 meters to 1.1 meters.

A pad 18 is positioned over a top of the second section of the frame when the frame is positioned as shown in FIG. 4. The pad protects the bicycle frames, and is secured to the top of the second section 6.

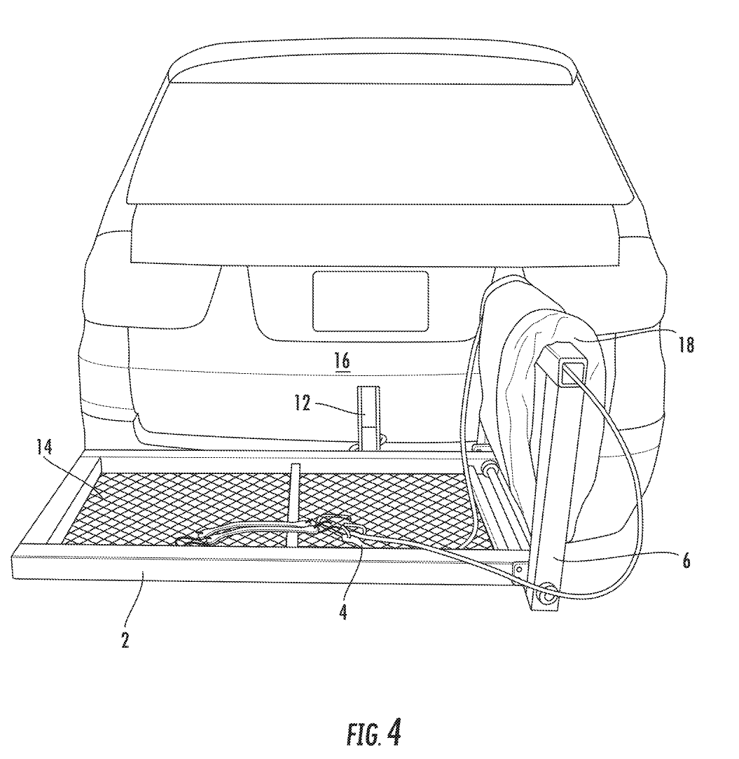

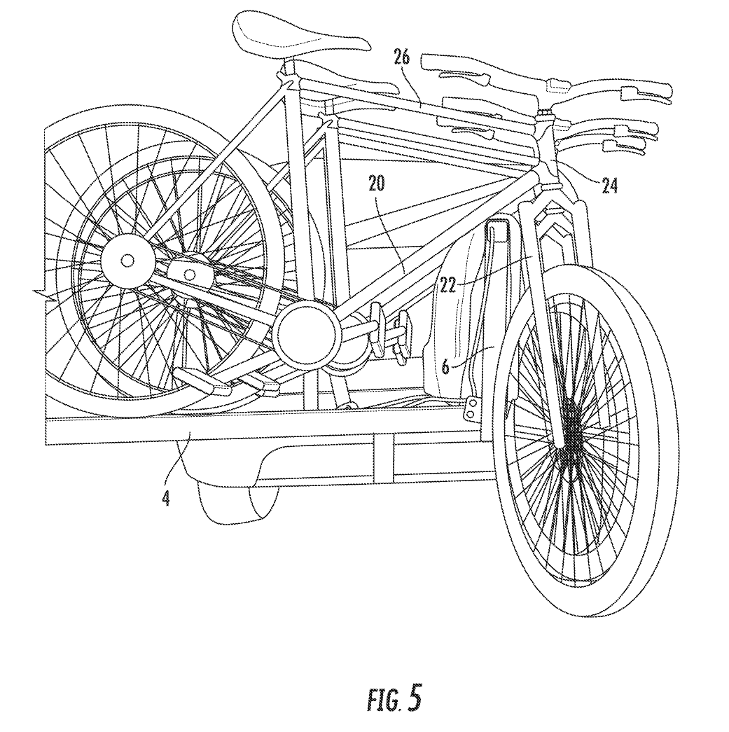

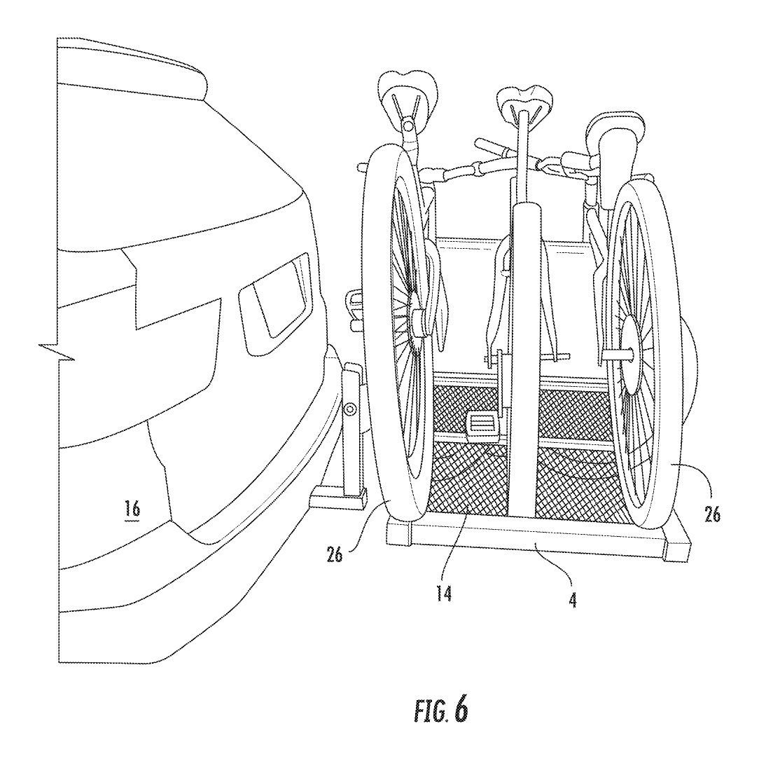

Bicycles are positioned on the bike rack as shown in FIG. 5 and FIG. 6. The second section is positioned between the down tube 20 and the front fork 22 of each bicycle. The down tubes of the bicycles rest on the pad 18 that is positioned on top of the second section of the frame. The top of the second section is positioned near the fork crown 24, but below the fork crown, which is typical for most applications. The front wheels of the bicycles extend beyond the second section and below the frame, and are not directly supported by the bike rack. The rear wheels rest on the floor 14 of the first section of the frame. As shown, the frame 2 may have sufficient width for at least three bicycles.

The bicycles 26 may be secured to the bike rack frame by lines, cables 30 and/or cords 32. In one embodiment a cable extends from each side of the top of the second section of the frame. The cable may be pulled against the bicycle frames to secure the bicycles.

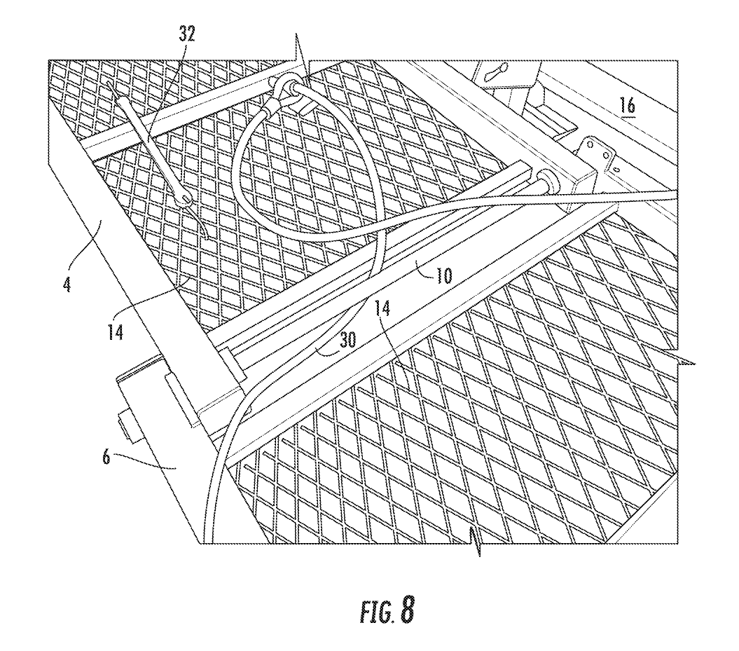

Elements of a bicycle frame are shown FIG. 10. The exemplary bicycle frame 50 of FIG. 10 includes a down tube 20, front fork 22, and fork crown 24 as previously presented herein. The bicycle frame 50 additionally includes a head tube 52, a top tube 54, a seat tube 56, a seat stay 58, a chain stay 60, a bottom bracket 62, a fork blade 64, and a fork rake 66 whose placement is shown in the exemplary representation in FIG. 10. Key features of the bicycle frame 50 include, for example, without intending to be limiting, a length of the top tube 54, a head angle defined by the position of the head tube 52 and the top tube 54, a height of the seat tube 56, a seat tube angle defined by the position of the top tube 54 and the seat tube 56, a bottom bracket height defined by the position of the bottom bracket 62 relative to the wheelbase, and a wheelbase distance measured from the confluence of the seat stay 58 and chain stay 60 to the fork rake 46. Down tubes on some bicycles are curved or arcuate, rather than straight as shown on the diamond frame of FIG. 10. The bike rack of the invention will accommodate either configuration, and will accommodate almost all bicycles, as well as children's bicycles.

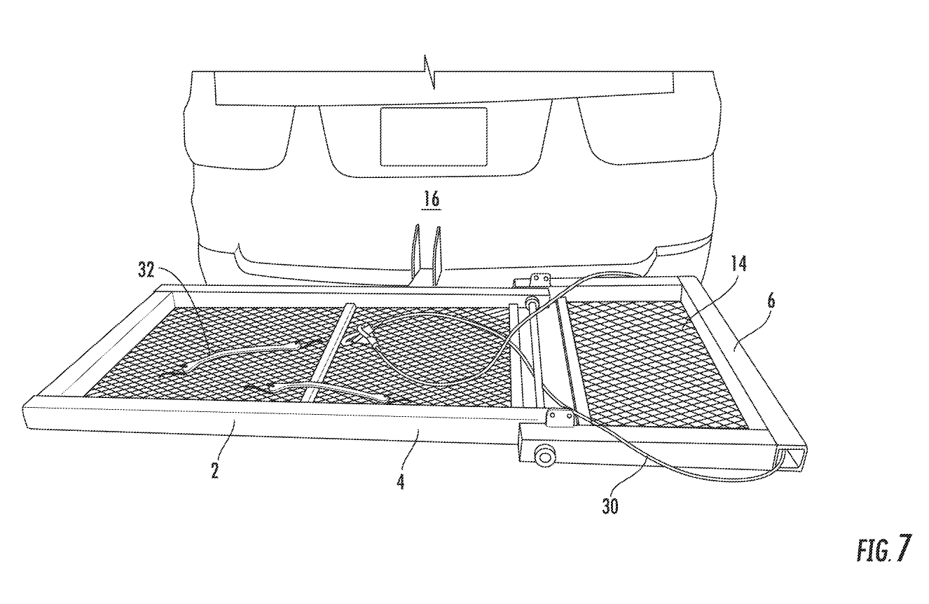

The bike rack is preferably convertible. FIG. 7. The second section 6 is repositioned to a horizontal position that is substantially level with the first section. The second section extends to approximately a side of the vehicle, which is the right side as shown. The relatively wide frame makes the bike rack useful for hauling other articles when not in use as a bike rack, which is not a use that is available with other hitch mounted bike racks. The pad 18 may be mounted to the second section while in the horizontal position. FIG. 9.

As shown in FIG. 8, an axle 10 permits the second section to rotate relative to the first section. The axle also joins the second section 6 to the first section 4. Stops hold the second section in a generally vertical position, then alternatively, in a generally horizontal position that is in substantially the same plane as the first section.

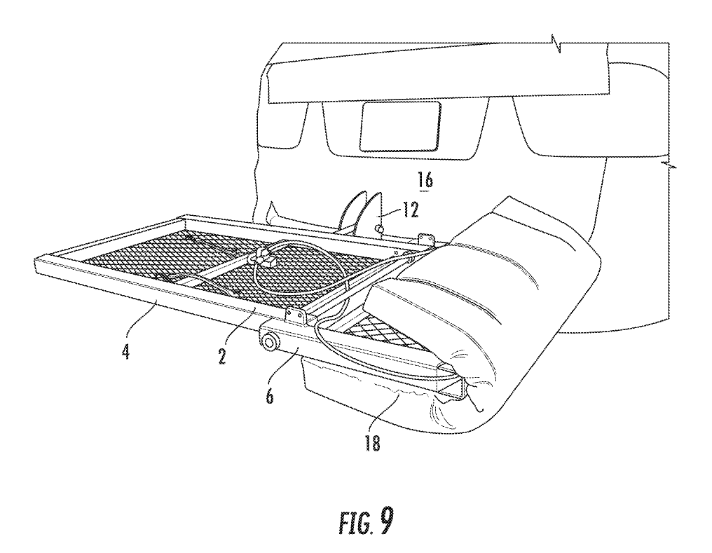

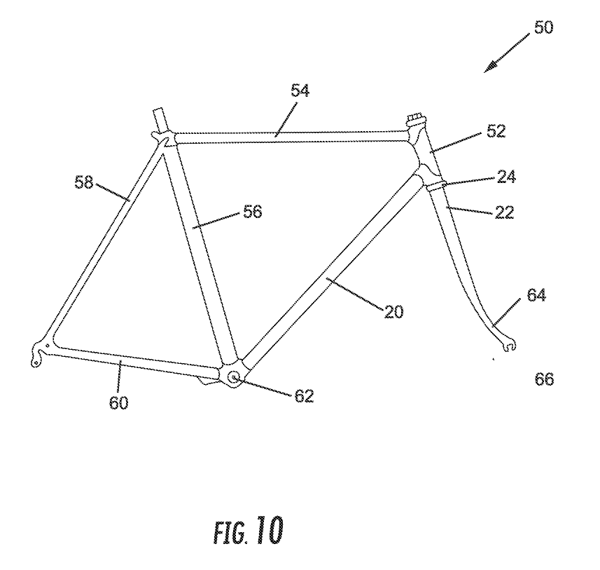

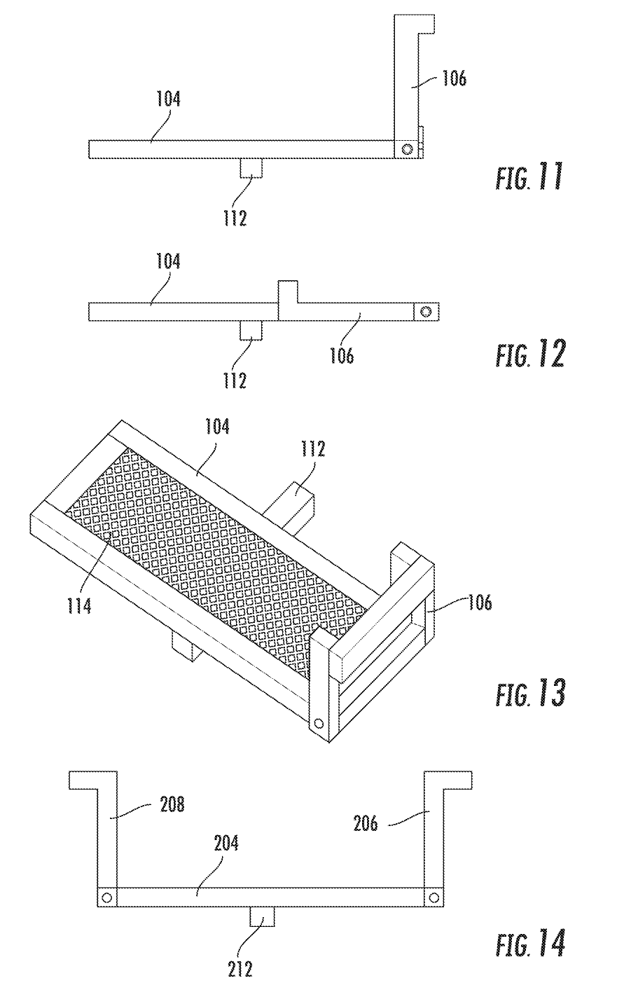

FIGS. 11 and 12 show another embodiment of the invention. In this embodiment, the first section 104 may be approximately centered relative to the vehicle hitch 112, whereas in the prior embodiment the hitch 112 is offset relative to the first section 4. The first section 104 is relatively longer than the first section 4, and may extend from about one side of the vehicle to about the opposite side of the vehicle in some applications. The first section has a floor 114. The width of this embodiment is preferred to be not less than 0.5 meters, and the length of the first section is preferred to be not less than 1.5 meters.

The second section 106 is positioned either in the vertical position as shown in FIGS. 11 and 12, or it is folded downwardly and over a portion first section. One of more stops prevents the second section 106 from being rotated past about a 90°, or a generally vertical, position. That is, the second section 106 cannot be rotated past about 90° and away from the first section. Since it is anticipated that the first section 104 will extend to about the side of the vehicle where the second section is attached, allowing the second section to rotate past vertical would, in some applications, cause the second section to undesirably extend past the side of the vehicle.

The relatively longer first section 104 allows bicycles of longer length to be carried than does the embodiment of first section 4. Mounting of the bicycle relative to the device employing second section 106 is the same as mounting the bicycle in the embodiment that employs first section 4 and second section 6, and as described herein. However, the front wheels of the bicycles in the embodiment of first section 104 may, in use, extend beyond the side of the vehicle.

FIG. 14 shows a pivoting second section 206 that is attached to the first section. This embodiment also has a pivoting third section 208 that is attached to the first section at an end that is opposite the second section. The first section 204 is generally centered relative to the vehicle. The second and third sections, when in the vertical position, allow one or more bicycles to be positioned with the second section positioned between the front fork and the down tube, and one or more bicycles to be positioned with the third section positioned between the front fork and the down tube, depending on the width of the frame. In this embodiment, the frame may be wider than the frame of FIGS. 1-10, and may be, as shown in the embodiment of FIGS. 11-13, although this embodiment allows the frames of the bikes to be positioned closer together than does the embodiment of FIGS. 11-13. The handle bars are the widest part of a typical bicycle, and by positioning the first bicycle over the second section and positioning the second bicycle over the third section, the frames of the bicycles are generally parallel and closer together than if both bicycles are positioned over the second section, for example, with the handle bars side by side.

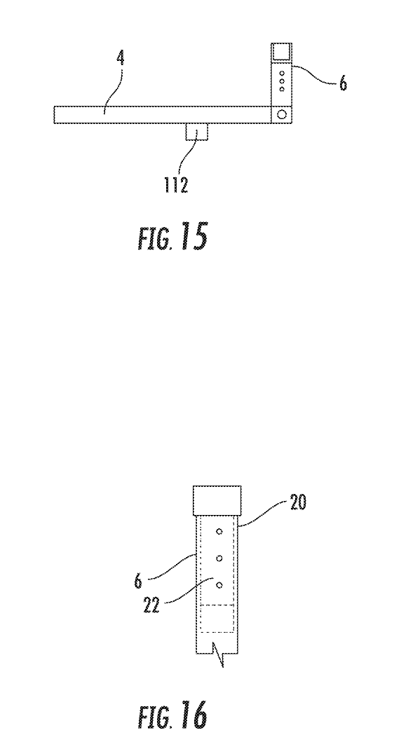

FIGS. 15 and 16 show a second section that telescopes to expand or reduce its length according to the size of the bicycle. A section 40 of the second section slidably engages an additional section 42. The length may be chosen by inserting a pin in a selected void in the sections, or known equivalents may be used to selectively choose a preferred length for the second section.

In use as a bike rack, the frame 2 is attached to the vehicle at the trailer hitch. The second section 6, 106, 206 (and third section if used) of the frame is pivoted relative to the vehicle 16 and moved from a generally horizontal orientation to a generally vertical orientation. The pad 18 is secured over the upper most part of the second section (and third section) when in the generally vertical orientation. One or more bicycles are positioned so that the length of the bicycle frames is generally perpendicular to the direction of travel of the vehicle. The rear wheel(s) are placed on the floor 14, 114 of the first section 4, 104, 204 and are supported by the floor. The second section is positioned between the front fork and the down tube of the bicycle(s), with the down tube supported by the pad and the upper most part of the second section. The front wheel(s) of the bicycle(s) are not directly supported by the bike rack. The bicycle(s) in this position will statically rest on the bike rack. To secure the bicycle(s) for travel, cables and/or cords and/or lines may be attached to the bicycles(s) and the bike rack to hold the bicycle(s) in place. The bicycle(s) may be removed by removing the cables and/or cords and/or lines from the bicycle(s) and lifting the bicycles away from the bike rack. The second section may then be pivoted to a generally horizontal orientation, and the bike rack used to transport other items.

Many modifications and other embodiments of the invention set forth herein will come to mind to one skilled in the art to which this invention pertains having the benefit of the teachings presented in the descriptions herein. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

1. A bike rack comprising:
a mounting assembly to attach the bike rack to a vehicle;
a frame having
a first section joined to the mounting assembly, the first section having a first end at substantially one side of the vehicle that continues to extend past the mounting assembly, and
a second section joined to the first section at a second end opposite to the first end of the first section, the second section extends substantially to an other side opposite of the one side of the vehicle; and
a floor mounted to the first section,
wherein upon attachment of the bike rack to the vehicle, the first section is substantially horizontal relative to the vehicle, while the second section is substantially vertical relative to the vehicle when a bicycle is mounted to the bike rack.

2. The bike rack of claim 1, wherein the mounting assembling is a trailer hitch.

3. The bike rack of claim 1, wherein the floor comprises perforations.

4. The bike rack of claim 3, wherein the perforations are geometrically shaped.

5. The bike rack of claim 4, wherein the perforations are diamond shaped.

6. The bike rack of claim 1, wherein the floor is a flat planar surface.

7. The bike rack of claim 1, wherein the first section occupies in the range of from 50 to 70 percent of an overall length of the bike rack.

8. The bike rack of claim 1, wherein a width of the bike rack is from 0.45 meter to 1.1 meters.

9. The bike rack of claim 1, additionally comprising a pad that is positioned over a top of the second section.

10. The bike rack of claim 9, wherein the second section is configured to be positioned between a down tube and a front fork of the bicycle and the down tube rests on the pad.

11. The bike rack of claim 10, wherein the top of the second section is positioned below the fork crown.

12. The bike rack of claim 10, wherein a front wheel of the bicycle extends beyond the second section and below the frame and not directly supported by the bike rack, and a rear wheel of the bicycle rests on the floor of the first section.

13. The bike rack of claim 1, wherein the second section may rotatably pivot downwardly and over a portion of the first section.

14. The bike rack of claim 13, additionally comprising a pivoting third section attached to the first end of the first section.

15. The bike rack of claim 1, wherein a length of the second section telescopes to expand or reduce to adjust to the size of the bicycle.

16. The bike rack of claim 15, wherein a section of the second section slidably engages an additional section and a pin is inserted into corresponding selected voids of each of the sections to selectively choose a preferred length for the second section.

17. A method of using a bike rack comprising:
attaching a bike rack to a vehicle using a mounting assembly, the bike rack additionally comprising a frame having a first section joined to the mounting assembly and a second section joined to an end of the first section;
pivoting the second section from a generally horizontal orientation relative to the vehicle to a generally vertical orientation relative to the vehicle;
positioning a bicycle so that a length of a frame of the bicycle is generally perpendicular to a direction of travel of the vehicle and the second section is positioned between a front fork and a down tube of the bicycle with the down tube of the bicycle being supported by the upper most part of the second section; and
placing a rear wheel of the bicycle on a floor of the first section;

18. The method of claim 17, additionally comprising securing a pad over an upper most part of the second section when in the generally vertical orientation with the down tube of the bicycle additionally being supported by the pad.

19. The method of claim 17, additionally comprising securing the bicycle for travel to the bike rack with the use of at least one of a cable, a cord, and a line.

20. The method of claim 17, additionally comprising pivoting a third section attached to another end of the first section opposite to the end where the second section is attached.
